(19) United States
(12) Patent Application Publication
(10) Pub. No.: US 2025/0111096 A1
(43) Pub. Date: Apr. 3, 2025

(54) METHODS AND APPARATUS TO PROTECT AGAINST VOLTAGE GLITCH ATTACKS IN MICROCONTROLLERS

(71) Applicant: Texas Instruments Incorporated, Dallas, TX (US)

(72) Inventors: Veeramanikandan Raju, Bangalore (IN); Anand Kumar G, Bangalore (IN)

(21) Appl. No.: 18/375,732

(22) Filed: Oct. 2, 2023

(51) Int. Cl. G06F 21/75

(52) U.S. Cl. CPC G06F 21/755

(57) ABSTRACT

Methods, apparatus, systems, and articles of manufacture are disclosed to protect against voltage glitch attacks in microcontrollers. An example apparatus includes logic circuitry operable to, in response to a voltage glitch, pause processing circuitry; number generator circuitry operable to generate a number; a counter operable to, after the voltage glitch ends, adjust a count corresponding to the number; and the logic circuitry operable to unpause the processing circuitry after the count reaches a value.

### RELATED APPLICATIONS

The present application is related to commonly assigned U.S. patent application Ser. No. 18/309,340, titled “VOLTAGE GLITCH DETECTOR,” filed on Apr. 28, 2023. U.S. patent application Ser. No. 18/309,340 is hereby incorporated herein by reference in its entirety.

### TECHNICAL FIELD

This description relates generally to circuits, and, more particularly, to methods and apparatus to protect against voltage glitch attacks in microcontrollers.

### BACKGROUND

Microcontrollers and/or other computing devices include processing circuitry (e.g., central processing units, graphics processing units, and/or any other type of processing units) that rely on a clock signal to execution instructions and/or to synchronize with other components connected to the processing circuitry. In some examples, the clock signal may be generated by an oscillator. When processing circuitry starts up, boots, and/or initializes, the processing circuitry uses the clock signal for basic timing and control to execute the instructions needed to startup, boot, and/or initialize.

### SUMMARY

An example of the description includes an apparatus which includes logic circuitry operable to, in response to a voltage glitch, pause processing circuitry; number generator circuitry operable to generate a number; a counter operable to, after the voltage glitch ends, adjust a count corresponding to the number; and the logic circuitry operable to unpause the processing circuitry after the count reaches a value.

### BRIEF DESCRIPTION OF THE DRAWINGS

FIG. 1 is an example microcontroller described in conjunction with examples described herein.

FIG. 2 is a block diagram of an example of single glitch protection circuitry of FIG. 1.

FIG. 3 is a block diagram of an example of multi-glitch protection circuitry of FIG. 1.

FIG. 4 is a flowchart representative of a method and/or operations that may be executed to implement the single glitch protection circuitry of FIG. 1.

FIG. 5 is a flowchart representative of a method and/or operations that may be executed to implement the multi-glitch protection circuitry of FIG. 1.

FIGS. 6-7 illustrate timing diagrams corresponding to output signals of components in the single glitch protection circuitry of FIG. 1.

FIGS. 8-9 illustrate timing diagrams corresponding to output signals of components in the multi-glitch protection circuitry of FIG. 1.

The same reference numbers or other reference designators are used in the drawings to designate the same or similar (functionally and/or structurally) features.

### DETAILED DESCRIPTION

The drawings are not necessarily to scale. Generally, the same reference numbers in the drawing(s) and this description refer to the same or like parts. Although the drawings show regions with clean lines and boundaries, some or all of these lines and/or boundaries may be idealized. In reality, the boundaries and/or lines may be unobservable, blended and/or irregular.

Microcontrollers and/or other controllers are implemented in a variety of electronics to perform operations and/or tasks. Such controllers include processing circuitry (e.g., CPU(s), a GPU(s), etc.) to facilitate the execution of instructions to perform the operations and/or tasks in conjunction with other peripheral devices (e.g., sensors, motors, keyboards, user interfaces, etc.). The processing circuitry utilizes a clock signal to execute the instructions. Accordingly, microcontrollers include and/or are connected to one or more clock oscillators that generate the clock signal(s) that the processing circuitry uses to execute the instructions. A power source (e.g., a battery, a plug, etc.) is connected to a terminal of the microcontroller (e.g., a VDD terminal, a digital logic VDD (VDDD) terminal, etc.) to provide power to the components of the microcontroller.

During startup, boot, reboot, initialization, etc., the processing circuitry of a microcontroller execute various instructions to prepare for operation. Such instructions may cause one or more values in registers of the microcontroller to be set to configure different configurations. Such instructions may correspond to the initialization of security protocols to protect the microcontroller from attacks such as unintended debug settings or denial of service attacks.

Some attackers may attempt to corrupt the information in the microcontroller by applying a voltage glitch, a clock glitch, electromagnetic injection, etc. For example, during startup, an attacker may apply a voltage glitch to the supply voltage terminal to decrease the supply voltage. When the supply voltage drops, the processing circuitry may unintentionally skip one or more operations. Thus, an attacker can apply a voltage glitch during startup to attempt to cause the processing circuitry to skip security protocols and/or debug configurations during startup and then take advantage/exploit of the security loopholes created by the voltage glitch during startup.

Voltage glitch detection circuitry can be implemented in a microcontroller to identify a voltage glitch. Voltage glitch detection circuitry can be implemented to identify a voltage glitch at the supply voltage terminal, an internal voltage rail, and/or any other terminal or rail of the microcontroller. When the voltage glitch detection circuitry detects a voltage glitch, the voltage glitch detection circuitry outputs a signal (e.g., a high voltage) to indicate that a voltage glitch is occurring. Additional example details of voltage glitch detection can be found in commonly assigned U.S. patent application Ser. No. 18/309,340, which is referenced in paragraph [0001] of this specification.

Some microcontrollers use the voltage glitch indication signal to reset the processing circuitry. Resetting the processing circuitry clears the information that the processing circuitry configured up to the point where the voltage glitch occurs and restarts the startup, boot, initialization process from the beginning. Although resetting the processing circuitry protects against a glitch-based attack, the reset processing takes time and/or resources to redo the instructions performed before the voltage glitch. Accordingly, resetting the processing circuitry in response to a glitch can lead to latency and/or power consumption overhead.

Examples disclosed herein utilize logic circuitry to protect a microcontroller from voltage glitch-based attacks without the latency and/or power overhead associated with resetting the processing circuitry. Examples disclosed herein utilize logic circuitry to pause operation of the processing circuitry in response to a detected voltage glitch. Examples disclosed herein can include logic circuitry configurable to pause operation of the processing circuitry by gating the clock signal (e.g., preventing processing circuitry from receiving the clock signal from the clock oscillator). However, the logic circuitry may be configurable to pause the processing circuitry using any function and/or operation that causes processing circuitry to stop or halt the normal execution of code. If the processing circuitry does not receive a clock signal, the processing circuitry will halt the execution of instructions, thereby pausing operation until the clock signal is received. After the glitch detection circuitry determines that the voltage glitch has ended, examples disclosed herein may include circuitry configurable to generate a random number and wait for a duration of time corresponding to the random number until unpausing the processing circuitry (e.g., ungating the clock signal so that the processing circuitry will receive the clock signal and continue operation). Randomizing the time to unpause after a glitch provides extra security from the attacker. For example, if the attacker attempts to apply multiple glitches, the attacker will not be able predict the timing of the glitch protection protocol if the timing is different for each detected glitch. Examples disclosed herein also utilize logic circuitry to protect other components of the microcontroller (e.g., accelerators, sub-systems, registers, etc.) by locking such components based on the detected voltage glitch.

Additionally, examples disclosed herein utilize logic circuitry to track and/or mitigate against multiple-glitches. Examples disclosed herein may utilize logic circuitry to track the number of identified glitches (e.g., the total number of glitches and/or a number of glitches that have occurred within a threshold amount of time) using one or more counters. When the one or more counters reach a user-defined threshold, examples disclosed herein utilize logic circuitry to halt operations of the processing circuitry (e.g., by causing the processing circuitry to enter standby mode). As used herein, standby mode may include a sleep mode, a low-power mode, and/or any mode different than a normal operating mode. Examples disclosed herein may include circuitry configurable to block and/or delay any instruction to exit the halted and/or standby mode until after random duration of time to provide extra security from an attacker. Using examples disclosed herein, electronic devices such as microcontrollers can protect against voltage glitches in a fast and efficient manner.

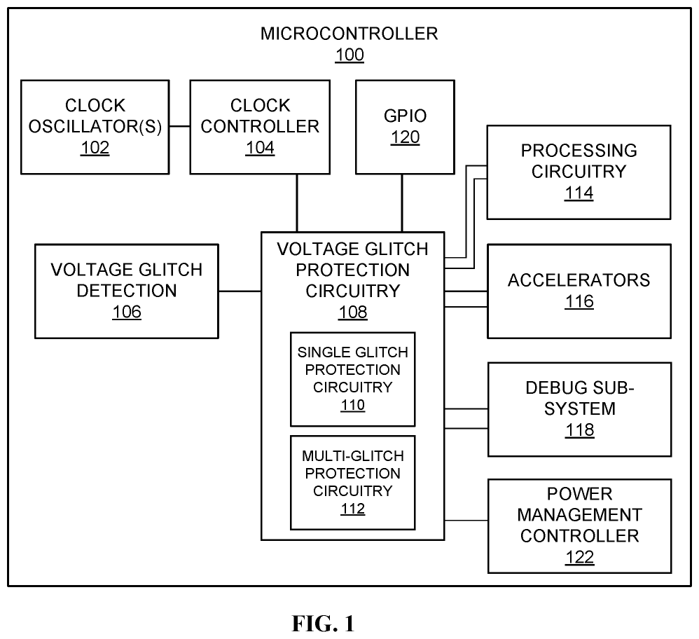

FIG. 1 illustrates an example microcontroller 100. However, the microcontroller 100 may be another controller device, including any semiconductor device or integrated circuit such as a power management integrated circuit. The example microcontroller 100 includes one or more clock oscillators 102, an example clock controller 104, example voltage glitch detection circuitry 106, example voltage glitch protection circuitry 108, example single glitch protection circuitry 110, example multi-glitch protection circuitry 112, example processing circuitry 114, example accelerators 116, an example debug sub-system 118, example general purpose input output (GPIO) 120, and an example power management controller 122.

The clock oscillator(s) 102 of FIG. 1 is a device to generate a clock signal. The clock oscillator(s) 102 may include one or oscillators to generate a periodic signal that the processing circuitry 114 can use to execute instructions. For example, the clock oscillator(s) 102 may include a first oscillator to generate a first clock signal with a first frequency and a second oscillator to generate a second clock signal with a second frequency. The clock oscillator(s) 102 output the generated clock signal to the clock controller 104. In some examples, the clock oscillator(s) 102 may be implemented outside of the microcontroller 100 and the clock signal may be provided by the external clock oscillator via a terminal of the microcontroller 100. The clock controller 104 of FIG. 1 sources the system clocks from a range of the clock oscillator(s) 102 and distribute the clock signals to other components of the microcontroller 100 via the voltage glitch protection circuitry 108.

The voltage glitch detection circuitry 106 of FIG. 1 is circuitry that detects a voltage glitch on an internal and/or external rail. For example, the voltage glitch detection circuitry 106 can detect a voltage glitch at the VDDD terminal of the microcontroller 100, an internal bus, and/or any other terminal or bus. As described above, a voltage glitch (e.g., also referred to as a voltage undershoot) corresponds to a voltage at a terminal or node dropping below an intended value. Accordingly, the voltage glitch detection circuitry 106 determines when the voltage at the terminal or node is below a threshold. In some examples, the voltage glitch detection circuitry 106 additionally or alternatively identifies a voltage glitch based on the slope and/or width of the voltage glitch. During the voltage glitch, the voltage glitch detection circuitry 106 outputs a signal indicative of the voltage glitch. For example, when there is no voltage glitch, the voltage glitch detection circuitry 106 may output a first voltage (e.g., 0 Volts (V) or a logic low). When there is a voltage glitch, the voltage glitch detection circuitry 106 may output a second voltage (e.g., 1.3 V or a logic high). The output of the voltage glitch detection circuitry 106 is output to the voltage glitch protection circuitry 108.

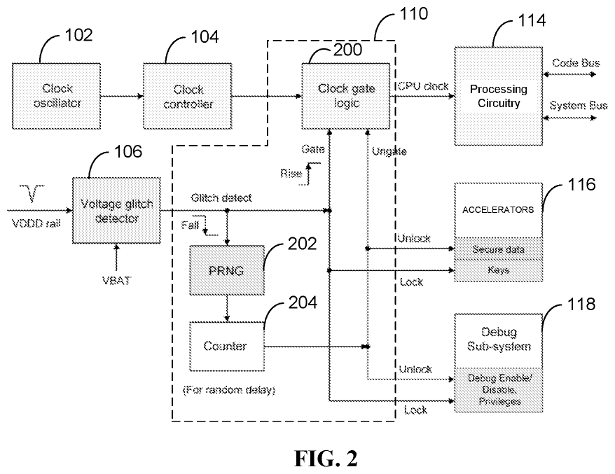

The voltage glitch protection circuitry 108 of FIG. 1 protects against a voltage glitch identified by the voltage glitch detection circuitry 106. The voltage glitch protection circuitry 108 includes the single glitch protection circuitry 110 and the multi-glitch protection circuitry 112. In some examples, the single glitch protection circuitry 110 and the multi-glitch protection circuitry 112 are made up of hardware components and do not rely on instructions from the processing circuitry 114 to operate. In other examples, the voltage glitch protection circuitry 108 can include a combination of hardware and software (e.g., hardware-assisted or software) to implement the techniques described herein. In this manner, when the processing circuitry 114 is paused, the voltage glitch protection circuitry 108 can continue operation. The single glitch protection circuitry 110 determines how to handle a detected glitch. For example, the single glitch protection circuitry 110 determines whether to pause the processing circuitry 114, lock the accelerators 116, lock the debug sub-system 118, and/or reset the processing circuitry 114 in response to a voltage glitch. For example, the single glitch protection circuitry 110 can pause the processing circuitry 114, and/or lock accelerators 116 and/or debug sub-system 118 if the voltage glitch drops below a first threshold voltage (e.g., below 1.08 V). Additionally, the single glitch protection circuitry 110 can restart, reboot, etc. the processing circuitry 114 if the voltage glitch drops below a second threshold voltage (e.g., 0.6 V). After the voltage glitch ends, the single glitch protection circuitry 110 may be configurable to wait for a random amount of time (e.g., a pseudo-random or quasi-random amount of time) before unpausing the processing circuitry 114, and/or unlocking the accelerators 116 and/or the debug sub-system 118. Although the single glitch protection circuitry 110 pauses and/or locks the components and/or devices shown in FIG. 2, the single glitch protection circuitry 110 may pause and/or lock any component and/or device of the microcontroller 100 in response to a detected voltage glitch. The example single glitch protection circuitry 110 is further described below in conjunction with FIG. 2.

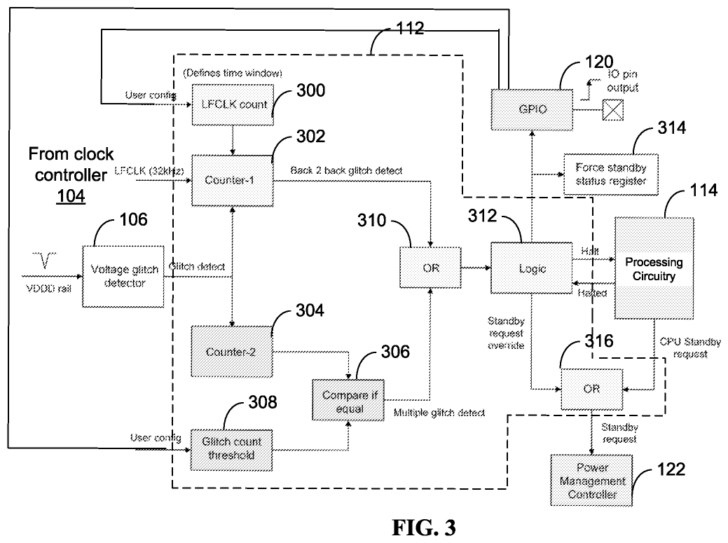

The multi-glitch protection circuitry 112 of FIG. 1 handles multiple glitches that may occur during a startup, boot, and/or initiation process. The multi-glitch protection circuitry 112 may include a first counter that tracks back-to-back glitches and/or a threshold number of glitches occurring within a threshold amount of time. Additionally, the multi-glitch protection circuitry 112 may include a second counter that tracks a threshold number of glitches throughout the entire startup, boot, and/or initialization process. If a back-to-back glitch (e.g., two glitches within a short amount of time) and/or a threshold total number of glitches occur, the multi-glitch protection circuitry 112 halts operation of the processing circuitry 114 by causing the processing circuitry 114 to enter a standby mode. For example, the multi-glitch protection circuitry 112 may instruct the power management controller 122 to enter the standby mode. Additionally, the multi-glitch protection circuitry 112 may transmit an indication of the multiple glitches to the GPIO 210 to provide an indication of the multiple glitches to a user (e.g., via a user interface). The multi-glitch protection circuitry 112 is further described below in conjunction with FIG. 3.

The processing circuitry 114 of FIG. 1 executes instructions. As described above, the processing circuitry 114 utilizes a clock signal generated by the clock oscillator(s) 102 to execute the instructions. Accordingly, when the voltage glitch protection circuitry 108 gates the clock signal, the processing circuitry 114 pauses or halts operation until the clock signal is ungated. The accelerators 116 of FIG. 1 are sub-systems and/or one or more processing devices that may perform computationally intensive operations (e.g., instead of being performed by the processing circuitry 114). In some examples, the accelerators 116 may be cryptographic accelerators (e.g., advanced encryption standard (AES) accelerator, public key accelerator (PKA), etc.) that install and/or store secure keys and/or other secure data. Accordingly, in response to a voltage glitch, the voltage glitch protection circuitry 108 locks the secure keys and/or secure data in the accelerators 116 to prevent tampering that may be caused by the glitch. In some examples, the voltage glitch protection circuitry 108 locks the accelerators 116 by changing the settings of a firewall to prevent access to the accelerators 116. The debug sub-systems 118 of FIG. 1 define and manage debug sessions and define and/or store information related to when to enable and/or disable debug mode, permission etc. Accordingly, in response to a voltage glitch, the voltage glitch protection circuitry 108 locks the information in the debug sub-systems 118 to prevent tampering that may be caused by the glitch.

FIG. 2 includes a block diagram of the example single glitch protection circuitry 110 of FIG. 1. FIG. 2 includes the oscillator(s) 102, the clock controller 104, the voltage glitch detection circuitry 106, the processing circuitry 114, the accelerators 116, and the debug sub-system 118 of FIG. 1. The single glitch protection circuitry 110 includes example clock gate logic circuitry 200, an example random number generator circuitry 202, and an example counter 204.

The clock gate logic circuitry 200 of FIG. 1 manages operation and/or access of the processing circuitry 114, the accelerators 116 and/or the debug sub-system 118 based on the output of the voltage glitch detection circuitry 106. The clock gate logic circuitry 200 obtains a clock signal from the clock controller. If the voltage glitch detection circuitry 106 is outputting a signal indicative of no voltage glitch, the clock gate logic circuitry 200 forwards the clock signal to the example processing circuitry 114 and does not lock any of the data in the accelerator 116 and/or the debug sub-system 118. When the voltage glitch detection circuitry 106 outputs a signal indicative of a voltage glitch, the clock gate logic circuitry 200 causes the processing circuitry 114 to pause execution of instructions. For example, the clock gate logic circuitry 200 may gate the clock signal to prevent the clock signal from reaching the processing circuitry 114. Without a clock signal, the processing circuitry 114 halts or pauses the execution of instructions. Additionally, when the voltage glitch detection circuitry 106 outputs a signal indicative of a voltage glitch, the clock gate logic circuitry 200 locks the information included in the accelerators 116 and/or the debug sub-system 118 so that the information cannot be altered or accessed. For example, the clock gate logic circuitry 200 may change the settings in a firewall to prevent access to the accelerators 116 and/or the debug sub-system 118. The clock gate logic circuitry 200 maintains the gated clock signal and/or the locked accelerators 116 and/or debug sub-system 118 until the clock gate logic circuitry 200 obtains a signal from the counter 204, as further described below. After the counter 204 outputs a signal to indicate the end of the pause, the clock gate logic circuitry 200 unpauses the processing circuitry 114, unlocks the accelerators 116, and/or unlocks the debug sub-system 118. For example, the clock gate logic circuitry 200 may ungate the clock signal to allow the clock signal to pass to the processing circuitry 114, thereby causing the processing circuitry 114 to continue operation were it left off. Additionally, the clock gate logic circuitry 200 may unlock the accelerators 116 and/or the debug sub-system 118. For example, the clock gate logic circuitry 200 may change the settings of the firewall to provide access to the accelerators 116 and/or the debug sub-system 118.

After the signal from the voltage glitch detection circuitry 106 indicates that the voltage glitch has ceased, the random number generator circuitry 202 of FIG. 2 generates a random number. The random number may be selected from a group of preselected numbers or may be any number within a range of numbers. As further described below, the random number is used to generate a random amount of delay before continuing operation after the voltage glitch ceases. The random number generator circuitry 202 outputs the generated number to the counter 204.

The counter 204 of FIG. 2 operates as a timer to generate an amount of delay based on the number generated by the random number generator circuitry 202. For example, the counter 204 obtains the number generated by the random number generator circuitry 202 and counts down from the number to a predefined value (e.g., 0) or up from a predefined number (e.g., 0) to the number. The counter 204 may use the clock signal from one of the clock oscillators 102 to increment or decrement the count. After the count corresponding to the random number is complete, the counter 204 outputs a signal to the clock gate logic circuitry 200 to trigger the unpausing of the processing circuitry 114 and/or the unlocking of the accelerators 116 and/or the debug sub-system 118. In this manner, the clock gate logic circuitry 200 will unpause operations at different times after different voltage glitches, thereby creating randomization to confuse and/or avoid additional attacks from an attacker.

FIG. 3 includes a block diagram of the example multi-glitch protection circuitry 112 of FIG. 1. FIG. 3 includes the voltage glitch detection circuitry 106, the processing circuitry 114, the GPIO 120, and the power management controller 122 of FIG. 1. The multi-glitch protection circuitry 112 includes an example clock count circuitry 300, example counter logic 302, an example counter 304, an example comparator 306, an example glitch count circuitry 308, example logic gates 310, 316, and example logic circuitry 312. FIG. 3 further includes an example force standby status register 314.

The example clock count circuitry 300 of FIG. 3 obtains a user selected and/or configured/configurable value. The value corresponds to a user defined and/or desired amount of time to set within the counter logic 302. In some examples, the clock count circuitry 300 is one or more registers that store the user defined value. After the threshold amount of time, the glitch count tracked by the counter logic 302 resets. Accordingly, the counter logic 302 tracks more than one glitch that occurs with the threshold duration of time (e.g., back-to-back glitches). The clock count circuitry 300 provides the user defined value to the counter logic 302.

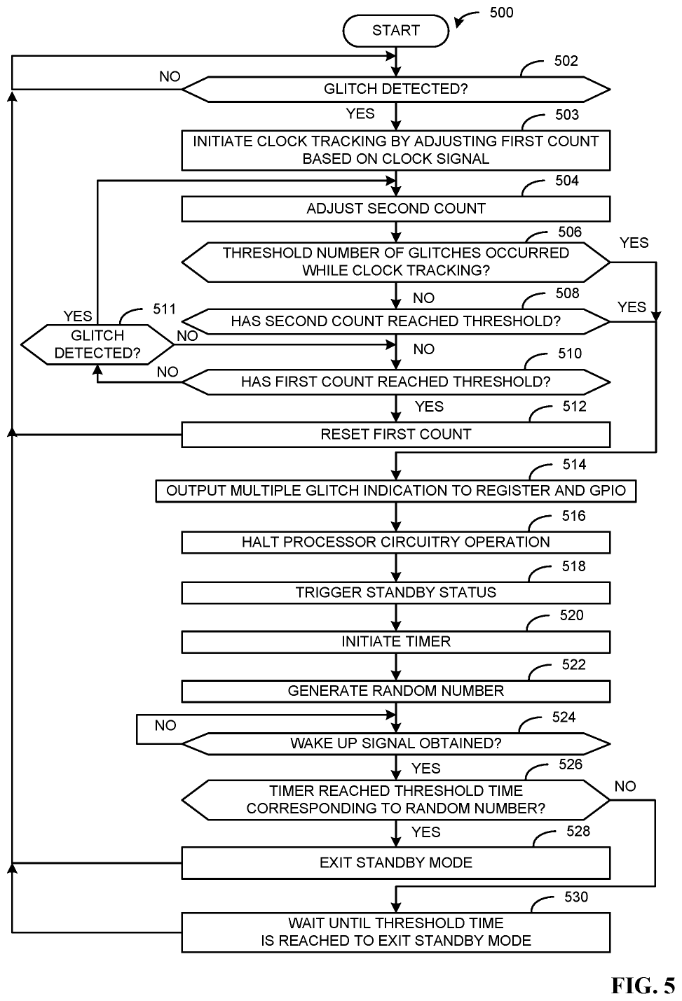

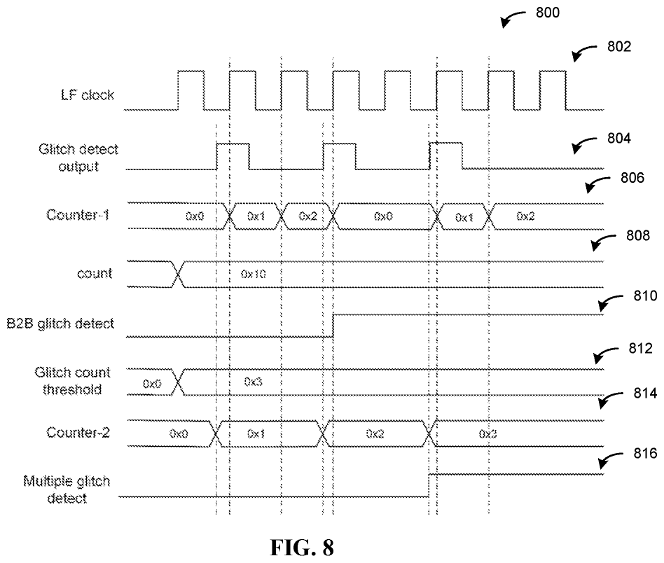

The counter logic 302 of FIG. 3 may be configurable to identify back to back glitches (e.g., two or more glitches that occur within a threshold amount of time). For example, the counter logic 302 may include a counter that increments a count based on every pulse of the clock signal after a voltage glitch occurs and resets the count after a threshold number of clock signal pulse(s). In such examples, the counter logic 302 outputs a first voltage (e.g., a low voltage or 0 V) unless a threshold number of glitches occur after the first glitch occurs. If a subsequent threshold number of glitches occur within the threshold amount of time before the count is reset, the counter logic 302 outputs a second voltage (e.g., a high voltage or 1.3 V). An example of adjusting a count based on the number of glitches is further described in conjunction with FIG. 5. In some examples, the counter logic 302 may be implemented in, as part of, or may be the same as the logic circuitry 312 and/or the logic An example of adjusting a count based on the clock signal is further described below in conjunction with FIG. 8.

The counter 304 of FIG. 3 tracks the total number of voltage glitches. Accordingly, when the output of the voltage glitch detection circuitry 106 reflects that new glitch is detected, the counter 304 adjusts (e.g., increments) to track the total number of identified voltage glitches. The comparator circuitry 306 accesses the count of voltage glitches in the counter 304 as further described below.

The comparator circuitry 306 of FIG. 3 accesses the total glitch count from the counter 304 and compares the total glitch count to a threshold to generate a total glitch count signal. The threshold may be a user defined threshold that is stored obtained via the GPIO 120 (e.g., via a user interface) and/or stored in the glitch count threshold circuitry 308. The glitch count threshold circuitry 308 may be one or more registers that store a user defined glitch count threshold provided by user via the GPIO 120 using a user interface. If the total glitch count is less than the threshold, the comparator circuitry 306 outputs a first voltage (e.g., 0 V or a logic low) to indicate that the total glitch count is below the threshold. If the total glitch count is more than the threshold, the comparator circuitry 306 outputs a second voltage (e.g., 1.3 V or logic high) to indicate that the total glitch count is above the threshold.

The example logic gate 310 of FIG. 3 is a logic OR gate. The logic gate 310 obtains a first signal from the counter logic 302 and a second signal from the comparator circuitry 306. The logic gate 310 outputs a first voltage (e.g., a logic high voltage or 1.3 V) when the output of the counter logic 302 and/or the output of the comparator 306 corresponds to a first voltage (e.g., a logic high or 1.3 V). The logic circuitry outputs a second voltage (e.g., a logic low or 0 V) when the output of the counter logic 302 and the output of the comparator 305 both correspond to a second voltage (e.g., logic low or 0 V). The output of the logic gate 310 is output to the logic circuitry 312.

The logic circuitry 312 of FIG. 3 performs one or more actions based on the output of the logic gate 310. For example, after the logic gate 310 switches from a second voltage (e.g., 0 V) to a first voltage (e.g., 1.3 V) indicative of more than a threshold number of glitches, the logic circuitry 312 performs tasks to halt operations of the processing circuitry 114 and cause the processing circuitry 114 to enter a standby mode for at least a threshold amount of time. In some examples, after the output of the logic gate 310 switches from the second voltage to the first voltage, the logic circuitry 312 causes the processing circuitry 114 to halt operations. The logic circuitry 312 may cause the processing circuitry 114 to halt operations by gating a clock signal (as described above in conjunction with FIG. 2) and/or by transmitting an instruction to the processing circuitry 114 to halt operations. The logic circuitry 312 waits for the processing circuitry 114 to assert the halt instructions and output a processing circuitry halted signal back to the logic circuitry 312. After obtaining the halted signal from the processing circuitry 114, the logic circuitry 312 de-asserts the processing circuitry halt input and drives the processing circuitry 114 to enter a low power mode and/or standby mode by transmitting a standby mode request to the power management controller 122 (e.g., via the logic gate 316).

In some examples, the logic circuitry 312 of FIG. 3 drives (e.g., outputs a logic high voltage) a pin of the GPIO 120 to provide the user with information related to the glitches, the glitch count, the standby mode, etc. The information may include the number of glitches, the type glitches (e.g., total number vs. back-to-back), the time the glitches occurred, the time standby mode was entered, etc. Additionally, the logic circuitry 312 may store a value in the force standby status register 314 to indicate that a force standby occurred. The logic circuitry 312 may include and/or be connected to a counter or timer to track a duration of time and/or a random number generator. In some examples, the random number generator could be implemented by the random number generator circuitry 202 of FIG. 2 and/or the counter or timer could be implemented by the counter 204 of FIG. 2. The random number generated can generate a random number after the logic circuitry 312 and/or the processing circuitry 114 outputs a standby request and the counter can adjust (e.g., increment or decrement) to and/or from the randomly generated number using a clock signal (e.g., obtained from one of the oscillators 102 of FIG. 1). In this manner, the logic circuitry 312 can prevent the exit of the standby mode (e.g., prevent a wake up) until after the count is complete. In this manner, an attacker cannot override the standby mode until after a duration of time that is randomized. In some examples, the logic circuitry 312 may be implemented in, as part of, or may be the same as the counter logic 302 and/or the clock gate logic circuitry 200 of FIG. 2.

The example logic gate 316 of FIG. 3 is a logic OR gate. The logic gate 316 obtains a first signal from the logic circuitry 312 and a second signal from the processing circuitry 114. The logic gate 316 outputs a first voltage (e.g., a logic high voltage or 1.3 V) when the output of the logic circuitry 312 and/or the output of the processing circuitry 114 corresponds to a first voltage (e.g., a logic high or 1.3 V). The logic circuitry outputs a second voltage (e.g., a logic low or 0 V) when the output of the logic circuitry 312 and the output of the processing circuitry 114 both correspond to a second voltage (e.g., logic low or 0 V). The output of the logic gate 316 is output to the power management controller 122. In this manner, the power management controller 122 can enter the standby mode in response to a trigger from the logic circuitry 312 and/or the processing circuitry 114.

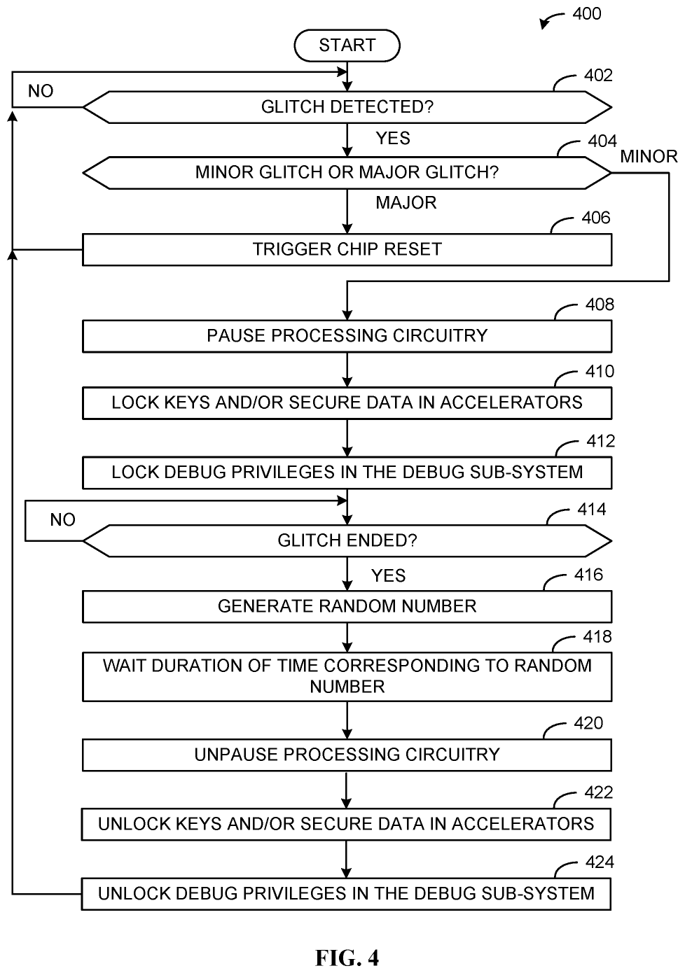

FIG. 4 is a flowchart representative of a method and/or example operations 400 that may be executed and/or instantiated by processing circuitry or any other circuitry of the microcontroller 100 of FIG. 1 to protect against a single voltage glitch. Although the instructions and/or operations of FIG. 4 are described in conjunction with the microcontroller 100 of FIGS. 1, the instructions and/or operations may be described in conjunction with any type of circuit that implements processing circuitry. Some processes shown in FIG. 4 may be performed in orders other than described, and many processes may be performed concurrently in parallel. Furthermore, processes shown in FIG. 4 may be omitted or substituted in some examples of the present disclosure.

The machine-readable instructions and/or the operations 400 of FIG. 4 begin at block 402, at which the clock gate logic circuitry 200 determines if a glitch is detected based on the output of the voltage glitch detection circuitry 106. For example, if the output of the voltage glitch detection circuitry 106 is a first voltage, the clock gate logic circuitry 200 determines that a glitch has not been detected. After the voltage glitch detection circuitry 106 changes the first voltage to a second voltage, the clock gate logic circuitry 200 determines that a glitch has been detected. In some examples the clock gate logic circuitry 200 determines a glitch is occurring based on a rising edge of the output of the voltage glitch detection circuitry 106. If the clock gate logic circuitry 200 determines that a glitch has not been detected (block 402: NO), control returns to block 402. If the clock gate logic circuitry 200 determines that a glitch has been detected (block 402: YES), the clock gate logic circuitry 200 determines if the glitch is major or minor (block 404). A minor glitch is a glitch that causes the supply voltage to drop below a first threshold (e.g., 1 V) and the major glitch is a glitch that causes the supply voltage to drop below a second threshold (e.g., 0.5 V). The second threshold is based on the amount of voltage drop that could cause a register to inadvertently change values (e.g., flip). In some examples, the voltage glitch detection circuitry 106 may transmit a first signal when the monitored voltage drops below the first threshold corresponding to the minor glitch and transmit a second signal when the monitored voltage drops below the second threshold corresponding to the major glitch. In some examples, two voltage glitch detection circuitries can be implemented in the microcontroller 100. For example, a first voltage glitch detection circuitry may detect minor glitches and the second voltage glitch detection circuitry may detect major glitches. In this manner, the clock gate logic circuitry 200 can determine whether the glitch is a major or minor glitch based on the output(s) of the one or more voltage glitch detection circuitries.

If the clock gate logic circuitry 200 determines that the glitch was a major glitch (block 404: MAJOR), the clock gate logic circuitry 200 triggers a chip reset by sending a reset instruction to the processing circuitry 114 (block 406). In this manner, any stored values that may have flipped due to the major glitch can be reset when the chip is reset and the startup, boot, and/or initialization process can restart. If the clock gate logic circuitry 200 determines that the glitch was a minor glitch (block 404: MINOR), the clock gate logic circuitry 200 pauses the processing circuitry 114 by gating the clock signal to prevent the processing circuitry 114 from obtaining the clock signal (block 408). As described above, without the clock signal, the processing circuitry 114 will not execute instructions. Accordingly, gating the clock signal pauses the processing circuitry 114 from executing instructions. Additionally or alternatively, the clock gate logic circuitry 200 may be configurable to pause the processing circuitry 114 by asserting a stall or halt signal, or using any other approach. At block 410, the clock gate logic circuitry 200 locks the keys and/or secures data in the accelerators 116. For example, the clock gate logic circuitry 200 may be configurable to impose read/write protection on the accelerators 116 so that no data can be read out or written to accelerators 116 during the lock period. As another example, the clock gate logic circuitry 200 may adjust firewall settings to prevent access to the keys and/or secure data of the accelerators 116. At block 412, the clock gate logic circuitry 200 locks the data in the debug sub-system 118. For example, the clock gate logic circuitry 200 may adjust firewall settings to prevent data access or alteration of the debug sub-system 118. Additionally or alternatively, the clock gate logic circuitry 200 may be configurable to cause one or more of the accelerators 116 to impose read/write protection.

At block 414, the clock gate logic circuitry 200 determines if the glitch has ended (e.g., based on a falling edge of the output of the voltage glitch detection circuitry 106). If the clock gate logic circuitry 200 determines that the glitch has not ended (block 414: NO), control returns to block 414 until the end of the glitch is detected. If the clock gate logic circuitry 200 determines that the glitch has ended (block 414: YES), the random number generator circuitry 202 generates a random number (block 416). In other examples, the clock gate logic circuitry 200 may be configurable to generate a non-random number with values that are difficult for an attacker to predict. As a result, the attacker may be unable to determine timing loop information about the device. At block 418, the counter 204 waits a duration of time corresponding to the random number (block 418). For example, the counter 204 can increment or decrement a counter to/from the random value from/to a preset value (e.g., zero) to wait a random duration of time corresponding to the random number. At block 420, after the random duration of time, the example clock gate logic circuitry 200 unpauses the processing circuitry 114 by ungating the clock signal to allow the processing circuitry 114 to receive the clock signal and continue execution of the instructions. Additionally or alternatively, the clock gate logic circuitry 200 may be configurable to deassert a stall or halt signal to unpause the processing circuitry 114. At block 422, the clock gate logic circuitry 200 unlocks the keys and/or secure data in the accelerators 116. For example, the clock gate logic circuitry 200 may adjust firewall settings to allow access to the keys and/or secure data of the accelerators 116. At block 424, the clock gate logic circuitry 200 unlocks the data in the debug sub-system 118. For example, the clock gate logic circuitry 200 may adjust firewall settings to allow data access or alteration of the debug sub-system 118. At block 424, control returns to block 402.

FIG. 5 is a flowchart representative of a method and/or example operations 500 that may be executed and/or instantiated by processing circuitry or any other circuitry of the microcontroller 100 of FIG. 1 to protect against a multiple voltage glitch. Although the instructions and/or operations of FIG. 5 are described in conjunction with the microcontroller 100 of FIGS. 1, the instructions and/or operations may be described in conjunction with any type of circuit that implements processing circuitry.

The machine-readable instructions and/or the operations 500 of FIG. 5 begin at block 502, at which the counter logic 302 and/or the counter 304 determine if a voltage glitch was detected. For example, the counter logic 302 and/or the counter 304 can determine that a voltage glitch was detected when the output of the voltage glitch detection circuitry 106 rises from a low voltage to a high voltage. If the counter logic 302 and/or the counter 304 determine that a glitch is not detected (block 502: NO), control returns to block 502 until a glitch is detected. If the counter logic 302 and/or the counter 304 determine that a glitch is detected (block 502: YES), the counter logic 302 initiate clock tracking by adjusting a first count based on a clock signal (block 503). At block 504, the counter 304 adjust the second count. For example, if the counter 304 is counting up to a threshold number, the second count will be incremented and, if the counter 304 is counting down from a threshold number, the second count will be decremented.

At block 506, the counter logic 302 determines if a threshold number of glitches has occurred while clock tracking (e.g., if there is a threshold number of glitches within a threshold duration of time (a back-to-back (B2B) glitch)). If the counter logic 302 determines that there was a threshold number of glitches that occurred while clock tracking (block 506: YES), control continues to block 514. If the counter logic 302 determines that the first count has not reached the first threshold (block 506: NO), the second counter 304 determines if the second count has reached a second threshold (block 508). In other words, the counter logic 302 may be configurable to determine whether the number of glitches has reached the second threshold while clock tracking. If the second counter 304 determines that the second count has reached the second threshold (block 508: YES) control continues to block 514. If the second counter 304 determines that the second count has not reached the second threshold (block 508: NO), the counter logic 302 determines if the first count has reached a threshold corresponding to a user defined threshold amount of time (block 510). If the counter logic 302 determines that the first count has reached the threshold (block 510: NO), the counter logic 302 and/or the counter 304 determine if a subsequent glitch is detected (block 511). If the first counter logic 302 determines that the first count has reached the threshold (block 510: YES), the counter logic 302 resets the first count (block 512) and control returns to block 502.

If the counter logic 302 and/or the counter 304 determine that the subsequent glitch has not been detected (block 511: NO), control returns to block 510. If the counter logic 302 and/or the counter 304 determine that the subsequent glitch has been detected (block 511: YES), control returns to block 504. At block 514, the example logic circuitry 312 determines that a glitch threshold has been reached (e.g., via the output of the logic gate 310) and the logic circuitry 312 outputs a multiple glitch indication signal to the force standby status register 314 and/or the GPIO 120. In this manner, information related to the multiple glitches can be provided to a user (via an interface) and/or other device via the GPIO 120 and an indication of a forced standby can be stored in the force standby status register 314. In some examples, the force standby status register 314 can indicate to the power management controller 122 and/or any other device whether a force standby is in place.

At block 516, the example logic circuitry 312 halts the processing circuitry operation. The logic circuitry 312 may halt processing circuitry operations by gating the clock signal and/or transmitting an instruction to the processing circuitry 114. At block 518, the logic circuitry 312 and/or the processing circuitry 114 triggers standby status by sending an instruction to the power management controller 122 (e.g., via the logic gate 316). At block 520, the logic circuitry 312 and/or the counter 204 initiates a timer and/or counter. At block 522, the example logic circuitry 312 and/or the random number generator circuitry 202 generates a random number. At block 524, the example logic circuitry 312 and/or the example power management controller 122 determines if a wake up signal has been obtained (e.g., via the GPIO 120). If the example logic circuitry 312 and/or the example power management controller 122 determines that a wake up signal has not been obtained (block 524: NO) control returns to block 524 until a wake up signal is obtained. If the example logic circuitry 312 and/or the example power management controller 122 determines that a wake up signal has been obtained (block 524 YES), the example logic circuitry 312 determines if the timer and/or count has reached a threshold based on the random number (block 526). For example, the timer and/or counter may be designed to count up to the random number or count down from the random number.

If the logic circuitry 312 determines that the timer and/or counter has reached a threshold based on the random number (block 526: YES), the logic circuitry 312 triggers an exit of standby mode by instructing the power management controller 122 to exit standby mode and/or by resetting the force standby status register 314 (block 528). In some examples, the power management controller 122 monitors the force standby status register 314 to determine when standby mode can be exited. Accordingly, the logic circuitry 312 may reset the register 314 so that the power management controller 122 can exit standby mode after the register 314 is reset and a request to exit standby mode has been obtained. If the logic circuitry 312 determines that the timer and/or the counter has not reached the threshold based on the random number (block 528), the logic circuitry 312 and/or the power management controller 122 waits until the threshold time is reached to exit the standby mode (block 530). As described above, the logic circuitry 312 can indicate that the threshold amount of time has been reached by sending an instruction to the power management controller 122 and/or by resetting the value in the register 314.

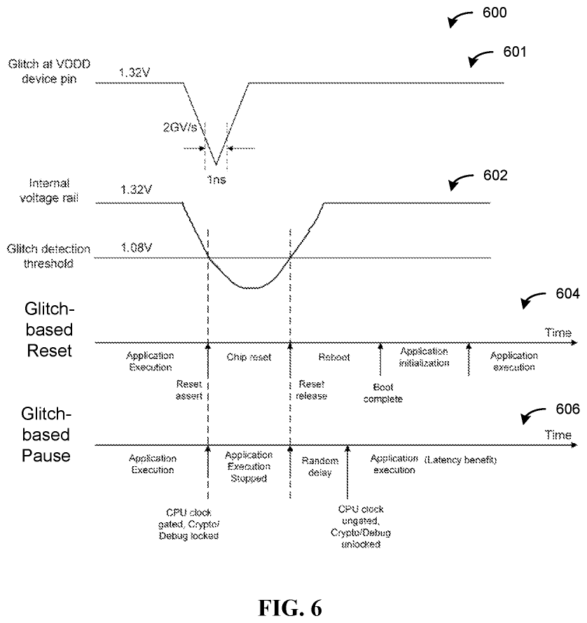

FIG. 6 is an example timing diagram 600 corresponding to an example timing of operations of the single glitch protection circuitry 110 of FIG. 2. The example timing diagram 600 includes an example input voltage 601, an example internal voltage 602, an example glitch-based reset timing diagram 604 and an example glitch-based pause timing diagram 606. The input voltage 601 corresponds to the input terminal (e.g., VDDD) of the microcontroller 100 of FIG. 1 that obtains voltage from a power source. The internal voltage 602 corresponds to the voltage rail that connects the input terminal of the microcontroller 100 to other components within the microcontroller 100. Although the timing diagrams of FIG. 6 correspond to particular voltage levels, the voltage levels, slopes, thresholds, etc. can correspond to any voltage levels, slopes, thresholds etc.

The input voltage 601 of FIG. 6 is set to a particular voltage (e.g., 1.32 V). However, as shown in the input voltage 601, a glitch causes the input voltage 601 to drop or undershoot the intended voltage for a duration of time. Due to the internal capacitance and/or inductance of components within the microcontroller 100, the glitch applied to the input voltage 601 at the input terminal of the microcontroller 100 results in a smoother and longer voltage dip on the internal voltage rail, as shown in the internal voltage 602. The glitch causes the internal voltage to drop below the glitch threshold of 1.08 V for a duration of time. When the voltage glitch detection circuitry 106 of FIG. 2 detects that the input voltage 601 and/or internal voltage 602 drops below the threshold, some techniques reset the chip (e.g., corresponding to diagram 604) while other techniques pause the processing circuitry (e.g., corresponding to diagram 606). In the diagram 604, after the glitch ends, the chip is rebooted and the processing circuitry has to re-initialize the application and redo any instruction execution performed before the glitch. In the diagram 606, after the glitch ends, the logic circuitry is configurable to cause the processing circuitry to resume operation after the random delay, thereby leading to latency and power savings improvement.

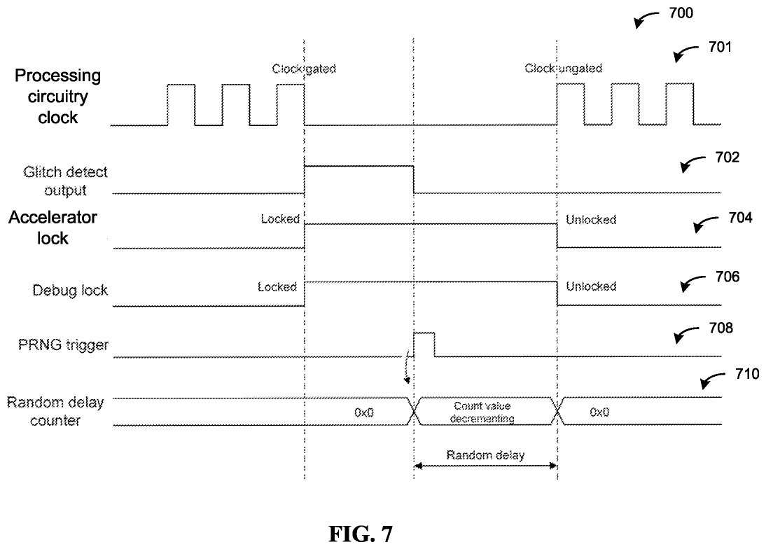

FIG. 7 is an example timing diagram 700 corresponding to an example timing of operations of the single glitch protection circuitry 110 of FIG. 2. The example timing diagram 700 includes an example processing circuitry clock signal 701, an example glitch detect output 702, an example accelerator lock signal 704, an example debug lock signal 706, an example random number generator trigger 708, and an example random delay counter signal 710. The example processing circuitry clock signal 701 corresponds to the clock signal obtained at the processing circuitry 114. The glitch detect output signal 702 corresponds to the output of the voltage glitch detection circuitry 106. The accelerator lock signal 704 and the debug lock signal 706 correspond to signal(s) output by the clock gate logic circuitry 200 to the accelerators 116 and the debug subsystem 117. The random delay counter 710 corresponds to the count tracked by the counter 204.

Prior to the glitch detect output signal 702 going from a low voltage to a high voltage, the clock signal 701 is oscillating. Accordingly, the processing circuitry 114 executes instructions based on the clock signal 701. After the glitch the output 702 goes to a high voltage (e.g., indicating that a voltage glitch is occurring), the single glitch protection circuitry 110 gates the clock signal 701 to prevent the processing circuitry from obtaining the clock signal. Accordingly, the clock signal 701 remains low until the single glitch detection circuitry ungates the clock signal. Additionally, the single glitch protection circuitry 110 locks the accelerator 116 and the debug sub-system 118 as shown in signals 704, 706. After the glitch ends and the glitch detect output signal 702 drops to a low voltage, the random number generator circuitry 202 is triggered to generate a random number. As indicated by the random number trigger signal 708. The counter 204 uses the random number to generate a random amount of delay (e.g., by incrementing a count to the random number, by incrementing a count from the random number, etc.) as shown at the random delay counter 710. After the random delay is over, the clock gate logic circuitry 200 ungates the clock signal and unlocks the accelerator 116 and the debug sub-system 118 as indicated by the processing circuitry clock signal 701, accelerator lock signal 704, and the debug lock signal 706.

FIG. 8 is an example timing diagram 800 corresponding to an example timing of operations of the multi-glitch protection circuitry 112 of FIG. 3. The example timing diagram 800 includes an example clock signal 802, an example glitch detect output signal 804, an example first count signal 806, an example count threshold signal 808, an example back-to-back glitch indication signal 810, an example total glitch count threshold signal 812, an example second count signal 814, and an example multiple glitch detection signal 816. The clock signal 802 corresponds to the output of one or the oscillators 102. The glitch detection output 804 corresponds to the output of the voltage glitch detection circuitry 106. The counter signal 806 corresponds to the count tracked by the counter logic 302. The first count signal 808 corresponds to the value stored in the count circuitry 300. The back-to-back (B2B) glitch indication signal 810 corresponds to the output of the counter logic 302. The glitch count threshold 812 corresponds to the value stored in the glitch count threshold circuitry 308. The second counter signal 814 corresponds to the count tracked by the counter 304. The multiple glitch detection signal 816 corresponds to the signal output by the comparator circuitry 306.

When the voltage glitch detection circuitry 106 detects a first glitch, as shown in the glitch detection output 804, the counter logic 302 initiates a count of the rising edge of the clock signal 802. However, the counter logic 302 may increment or decrement a count based on any portion of the clock signal 802. In the example of FIG. 8, the threshold number of clock pulses is based on the count signal 808 which corresponds to 16 clock pulses (e.g., hex 10). Thus, if a threshold number of glitches (e.g., a threshold of 2 in FIG. 8) occurs within the duration of time corresponding to 16 clock pulses, the B2B glitch detect signal is triggered, as shown in the B2B glitch indication signal 810. Additionally, the counter 304 tracks the total number of glitches that occurs. Accordingly, for every clock pulses of the glitch detect output signal 804, the counter 304 increments the total glitch count as shown in the second count signal 814. Because the glitch count threshold in FIG. 8 is set to 3, as shown in the glitch count threshold 812, the multiple glitch detection signal triggers when the counter signal 814 reaches a count of 3.

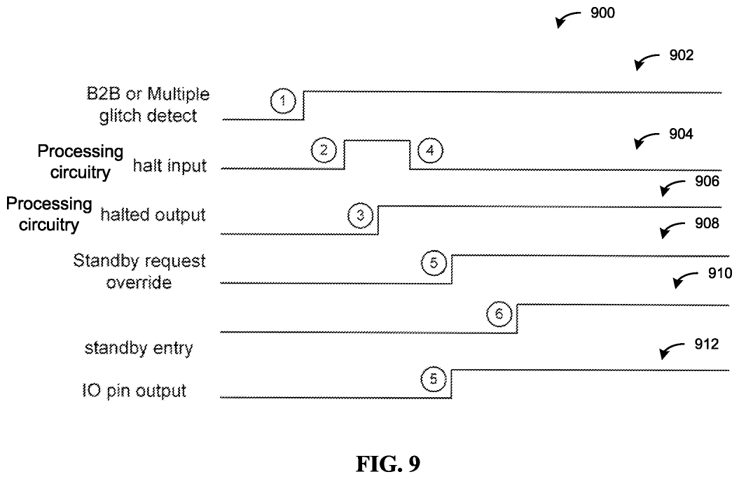

FIG. 9 is an example timing diagram 900 corresponding to an example timing of operations of the multi-glitch protection circuitry 112 of FIG. 3. The example timing diagram 900 includes an example B2B or multiple glitch detect signal 902, an example processing circuitry halt input signal 904, an example processing circuitry halted output signal 906, an example standby request override signal 908, an example standby entry signal 910, and an example IO pin output signal 912. The B2B or multiple glitch detect signal 902 corresponds to the output of the logic gate 310. The processing circuitry halt input signal 904 corresponds to an output from the logic circuitry 312 to the processing circuitry 114. The processing circuitry halted output signal 906 corresponds to an output signal from the processing circuitry 114 to the logic circuitry 312. The standby request override signal 908 corresponds to the output of the logic circuitry 312, the processing circuitry 114 and/or the logic gate 316 to the power management controller 122. The IO pin output signal 912 corresponds to an output of the GPIO 120.

After the B2B or multiple glitch detect signal 902 is triggered by the logic gate 310, the logic gate circuitry 312 triggers the processing circuitry halt input signal 904 to cause the processing circuitry 114 to halt and/or pause operation. After instructions are halted, the processing circuitry 114 responds by triggering the processing circuitry halted output signal 908. After the processing halted output signal 906 is triggered, the logic circuitry 312 and/or the processing circuitry 114 triggers the standby request override signal 908. As described above, the power management controller 122 initiates standby mode based on the trigger of the standby request override signal 908. Additionally, after the processing halted output signal 906 is triggered, the logic circuitry 312 triggers the IO pin output 912 via the GPIO 120 to indicate to a user or device that a force standby is occurring due to multiple glitches. After the standby override signal 908 is triggered, the power management controller 122 triggers standby entry, as shown in the standby entry signal 910.

An example manner of implementing the microcontroller 100 of FIG. 1 is illustrated in FIGS. 1-3. However, one or more of the elements, processes and/or devices illustrated in FIGS. 1-3 may be combined, divided, re-arranged, omitted, eliminated and/or implemented in any other way.

Further, the clock oscillator(s) 102, the clock controller 104, the voltage glitch detection circuitry 106, the voltage glitch protection circuitry 108, the single glitch protection circuitry 110, the multi-glitch protection circuitry 112, the processing circuitry 114, the accelerators 116, the debug sub-system 118, the GPIO 120, the power management controller 122, the clock gate logic circuitry 200, the random number generator circuitry 202, the counter 204, the clock count circuitry 300, the counter logic 302, the counter 304, the comparator circuitry 306, the glitch count threshold circuitry 308, the logic gates 310, 316, the logic circuitry 312, and/or the force standby status register 314 may be implemented by hardware, software, firmware and/or any combination of hardware, software and/or firmware. As a result, for example, any of the clock oscillator(s) 102, the clock controller 104, the voltage glitch detection circuitry 106, the voltage glitch protection circuitry 108, the single glitch protection circuitry 110, the multi-glitch protection circuitry 112, the processing circuitry 114, the accelerators 116, the debug sub-system 118, the GPIO 120, the power management controller 122, the clock gate logic circuitry 200, the random number generator circuitry 202, the counter 204, the clock count circuitry 300, the counter logic 302, the counter 304, the comparator circuitry 306, the glitch count threshold circuitry 308, the logic gates 310, 316, the logic circuitry 312, and/or the force standby status register 314 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)).

When reading any of the apparatus or system claims of this patent to cover a purely software and/or firmware implementation, at least one of the clock oscillator(s) 102, the clock controller 104, the voltage glitch detection circuitry 106, the voltage glitch protection circuitry 108, the single glitch protection circuitry 110, the multi-glitch protection circuitry 112, the processing circuitry 114, the accelerators 116, the debug sub-system 118, the GPIO 120, the power management controller 122, the clock gate logic circuitry 200, the random number generator circuitry 202, the counter 204, the clock count circuitry 300, the counter logic 302, the counter 304, the comparator circuitry 306, the glitch count threshold circuitry 308, the logic gates 310, 316, the logic circuitry 312, and/or the force standby status register 314 is/are hereby expressly defined to include a non-transitory computer readable storage device or storage disk such as a memory, a digital versatile disk (DVD), a compact disk (CD), a Blu-ray disk, etc., including the software and/or firmware. Further still, the clock oscillator(s) 102, the clock controller 104, the voltage glitch detection circuitry 106, the voltage glitch protection circuitry 108, the single glitch protection circuitry 110, the multi-glitch protection circuitry 112, the processing circuitry 114, the accelerators 116, the debug sub-system 118, the GPIO 120, the power management controller 122, the clock gate logic circuitry 200, the random number generator circuitry 202, the counter 204, the clock count circuitry 300, the counter logic 302, the counter 304, the comparator circuitry 306, the glitch count threshold circuitry 308, the logic gates 310, 316, the logic circuitry 312, and/or the force standby status register 314 may include one or more elements, processes and/or devices in addition to, or instead of, those illustrated in FIGS. 1-3, and/or may include more than one of any or all of the illustrated elements, processes, and devices. As used herein, the phrase “in communication,” including variations thereof, encompasses direct communication and/or indirect communication through one or more intermediary components, and does not require direct physical (e.g., wired) communication and/or constant communication, but rather also includes selective communication at periodic intervals, scheduled intervals, aperiodic intervals, and/or one-time events.

Flowcharts representative of example hardware logic, machine-readable instructions, hardware implemented state machines, and/or any combination thereof for implementing the microcontroller 100 of FIGS. 1-3 are shown in FIGS. 4-5. The machine-readable instructions may be one or more executable programs or portion(s) of an executable program for execution by a computer processor. The program may be embodied in software stored on a non-transitory computer readable storage medium such as a CD-ROM, a floppy disk, a hard drive, a DVD, a Blu-ray disk, or a memory associated with the processor, but the entire program and/or parts thereof could alternatively be executed by a device other than the processor and/or embodied in firmware or dedicated hardware.

Further, although the example program is described with reference to the flowcharts illustrated in FIG. 4-5, many other methods of implementing the microcontroller 100 may alternatively be used. For example, the order of execution of the blocks may be changed, and/or some of the blocks described may be changed, eliminated, or combined. Also or alternatively, any or all of the blocks may be implemented by one or more hardware circuits (e.g., discrete and/or integrated analog and/or digital circuitry, a field-programmable gate array (FPGA), an application-specific integrated circuit (ASIC), a comparator, an operational-amplifier (op-amp), a logic circuit, etc.) structured to perform the corresponding operation without executing software or firmware.

The machine-readable instructions described herein may be stored in one or more of a compressed format, an encrypted format, a fragmented format, a compiled format, an executable format, a packaged format, etc. Machine-readable instructions as described herein may be stored as data (e.g., portions of instructions, code, representations of code, etc.) that may be utilized to create, manufacture, and/or produce machine executable instructions. For example, the machine-readable instructions may be fragmented and stored on one or more storage devices and/or computing devices (e.g., servers). The machine-readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine-readable instructions may be stored in multiple parts, which are individually compressed, encrypted, and stored on separate computing devices, in which the parts when decrypted, decompressed, and combined form a set of executable instructions that implement a program such as that described herein.

In another example, the machine-readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine-readable instructions may be configured (e.g., settings stored, data input, network addresses recorded, etc.) before the machine-readable instructions and/or the corresponding program(s) can be executed in whole or in part. As a result, the described machine-readable instructions and/or corresponding program(s) encompass such machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example processes of FIG. 8 may be implemented using executable instructions (e.g., computer and/or machine-readable instructions) stored on a non-transitory computer and/or machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

Example methods, apparatus and articles of manufacture have been described to improve accuracy and/or efficiency of current limit circuitry. The described methods, apparatus and articles of manufacture improve the accuracy and/or efficiency of current limit circuitry using a diode-connected device, a current source, and a gain stage.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

Descriptors “first,” “second,” “third,” etc. are used herein when identifying multiple elements or components which may be referred to separately. Unless otherwise specified or known based on their context of use, such descriptors do not impute any meaning of priority, physical order, or arrangement in a list, or ordering in time but are merely used as labels for referring to multiple elements or components separately for ease of understanding the described examples. In some examples, the descriptor “first” may be used to refer to an element in the detailed description, while the same element may be referred to in a claim with a different descriptor such as “second” or “third.” In such instances, such descriptors are used merely for ease of referencing multiple elements or components.

In the description and in the claims, the terms “including” and “having” and variants thereof are to be inclusive in a manner similar to the term “comprising” unless otherwise noted. Unless otherwise stated, “about,” “approximately,” or “substantially” preceding a value means +/−10 percent of the stated value. In another example, “about,” “approximately,” or “substantially” preceding a value means +/−5 percent of the stated value. IN another example, “about,” “approximately,” or “substantially” preceding a value means +/−1 percent of the stated value.

The term “couple” “coupled”, “couples”, and variants thereof, as used herein, may cover connections, communications, or signal paths that enable a functional relationship consistent with this description. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A via the control signal generated by device A. Moreover, the terms “couple”, “coupled”, “couples”, or variants thereof, includes an indirect or direct electrical or mechanical connection.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

Although not all separately labeled in the FIGS. 1-3, components or elements of systems and circuits illustrated therein have one or more conductors or terminus that allow signals into and/or out of the components or elements. The conductors or terminus (or parts thereof) may be referred to herein as pins, pads, terminals (including input terminals, output terminals, reference terminals, and ground terminals, for instance), inputs, outputs, nodes, and interconnects.

As used herein, a “terminal” of a component, device, system, circuit, integrated circuit, or other electronic or semiconductor component, generally refers to a conductor such as a wire, trace, pin, pad, or other connector or interconnect that enables the component, device, system, etc., to electrically and/or mechanically connect to another component, device, system, etc. A terminal may be used, for instance, to receive or provide analog or digital electrical signals (or simply signals) or to electrically connect to a common or ground reference. Accordingly, an input terminal or input is used to receive a signal from another component, device, system, etc. An output terminal or output is used to provide a signal to another component, device, system, etc. Other terminals may be used to connect to a common, ground, or voltage reference, e.g., a reference terminal or ground terminal. A terminal of an IC or a PCB may also be referred to as a pin (a longitudinal conductor) or a pad (a planar conductor). A node refers to a point of connection or interconnection of two or more terminals. An example number of terminals and nodes may be shown. However, depending on a particular circuit or system topology, there may be more or fewer terminals and nodes. However, in some instances, “terminal”, “node”, “interconnect”, “pad”, and “pin” may be used interchangeably.

Example methods, apparatus, systems, and articles of manufacture corresponding to protect against voltage glitch attacks in microcontrollers are disclosed herein. Further examples and combinations thereof include the following: Example 1 includes an apparatus comprising logic circuitry operable to, in response to a voltage glitch, pause processing circuitry, number generator circuitry operable to generate a number, a counter operable to, after the voltage glitch ends, adjust a count corresponding to the number, and the logic circuitry operable to unpause the processing circuitry after the count reaches a value.

Example 2 includes the apparatus of example 1, wherein the logic circuitry is operable to pause the processing circuitry by preventing the processing circuitry from receiving a clock signal.

Example 3 includes the apparatus of example 1, wherein the logic circuitry is operable to unpause the processing circuitry by allowing the processing circuitry to receive a clock signal.

Example 4 includes the apparatus of example 1, wherein the logic circuitry is to lock data in a sub-system.

Example 5 includes the apparatus of example 1, wherein the number is a first number, the count is a first count, the value is a first value, and the voltage glitch is a first voltage glitch, wherein the logic circuitry is operatable to in response to a second voltage glitch, pause the processing circuitry, the number generator circuitry is operable to generate a second number different than the first number, the counter is operable to, after the second voltage glitch ends, adjust a second count corresponding to the second number, and the logic circuitry is operable to unpause the processing circuitry after the second count reaches a second value.

Example 6 includes the apparatus of example 1, wherein the counter is a first counter, the count is a first count, and the logic circuitry is first logic circuitry, further including a second counter operable to adjust a second count in response to the voltage glitch, and output a multi-glitch indication signal when the second count satisfies a threshold, and second logic circuitry operable to cause the processing circuitry to enter standby mode based on the multi-glitch indication signal.

Example 7 includes the apparatus of example 6, wherein the threshold is user-defined.

Example 8 includes the apparatus of example 1, wherein the counter is a first counter, the count is a first count, and the logic circuitry is first logic circuitry, further including a second counter operable to output a back-to-back glitch indication signal when a subsequent voltage glitch is detected within a threshold duration of time, and second logic circuitry operable to cause the processing circuitry to enter standby mode based on the back-to-back glitch indication signal.

Example 9 includes the apparatus of example 8, wherein the threshold duration of time is user-defined.

Example 10 includes the apparatus of example 8, wherein the second logic circuitry is to generate a number, and prevent the processing circuitry from exiting the standby mode until a threshold amount of time corresponding to the number.

Example 11 includes a method comprising pausing execution of instructions by processing circuitry in response to a voltage glitch, generating a number, and unpausing the processing circuitry based on the number.

Example 12 includes the method of example 11, wherein the pausing of the execution of instructions by the processing circuitry includes preventing the processing circuitry from receiving a clock signal.

Example 13 includes the method of example 12, wherein the unpausing of the execution of instructions by the processing circuitry includes allowing the processing circuitry to receive the clock signal.

Example 14 includes the method of example 11, further including adjusting a count in response to the voltage glitch, and causing the processing circuitry to enter standby mode based on the count.

Example 15 includes the method of example 11, further including determining that a subsequent voltage glitch is detected within a threshold duration of time after detecting the voltage glitch, and causing the processing circuitry to enter standby mode in response to determining that the subsequent voltage glitch is detected within the threshold duration of time.

Example 16 includes an apparatus comprising counter logic circuitry operable to adjust a count based on a voltage glitch, and logic circuitry operable to cause processing circuitry to enter standby mode based on the count.

Example 17 includes the apparatus of example 16, wherein the logic circuitry is operable to prevent a terminal of the standby mode until a timer reaches a threshold duration.

Example 18 includes the apparatus of example 16, wherein the count is a count of clock pulses that occur after the voltage glitch, wherein the logic circuitry operatable to cause the processing circuitry to enter the standby mode if a subsequent voltage glitch is detected within a user-defined threshold amount of time.

Example 19 includes the apparatus of example 18, wherein the counter logic circuitry is operable to reset the count after the user-defined threshold amount of time.

Example 20 includes the apparatus of example 16, wherein the logic circuitry is operable to cause the processing circuitry to enter the standby mode by adjusting a value stored in a status register corresponding to the standby mode.

Example 21 includes the apparatus of example 16, wherein the count corresponds to a count of voltage glitches, wherein the logic circuitry is operable to cause the processing circuitry to enter standby mode when the count reaches a user-defined threshold. Modifications are possible in the described embodiments, and other embodiments are possible, within the scope of the claims.

What is claimed is:

1. An apparatus comprising:
logic circuitry operable to, in response to a voltage glitch, pause execution of instructions by processing circuitry; and
number generator circuitry operable to generate a number,
wherein the logic circuitry is operable to unpause the processing circuitry based on the number.

2. The apparatus of claim 1, wherein the logic circuitry is operable to pause execution of instructions by the processing circuitry by preventing the processing circuitry from receiving a clock signal.

3. The apparatus of claim 2, wherein the logic circuitry is operable to unpause the execution of instruction by the processing circuitry by allowing the processing circuitry to receive the clock signal.

4. The apparatus of claim 1, further comprising a sub-system, wherein the logic circuitry is operable to lock the sub-system in response to the voltage glitch.

5. The apparatus of claim 4, wherein the logic circuitry is operable to lock data stored in the sub-system in response to the voltage glitch.

6. The apparatus of claim 1, wherein the number is a first number, and the voltage glitch is a first voltage glitch, wherein:
the logic circuitry is operable to, in response to a second voltage glitch, pause the processing circuitry;
the number generator circuitry is operable to generate a second number different than the first number; and
the logic circuitry is operable to, based on the second number, unpause the processing circuitry after pausing the processing circuitry in response to the second voltage glitch.

7. The apparatus of claim 1, wherein the logic circuitry is first logic circuitry, the apparatus further including:
a counter operable to adjust a count in response to the voltage glitch; and
second logic circuitry operable to cause the processing circuitry to enter standby mode based on the count.

8. The apparatus of claim 7, wherein the second logic circuitry is operable to cause the processing circuitry to enter the standby mode in response to determining that the count satisfies a user-defined threshold.

9. The apparatus of claim 1, wherein the logic circuitry is first logic circuitry, the apparatus further including:
second logic circuitry operable to:
determine that a subsequent voltage glitch is detected within a threshold duration of time after detecting the voltage glitch; and
cause the processing circuitry to enter standby mode in response to determining that the subsequent voltage glitch is detected within the threshold duration of time.

10. The apparatus of claim 9, wherein the threshold duration of time is user-defined.

11. The apparatus of claim 9, wherein the number is a first number, and wherein the second logic circuitry is operable to:
generate a second number; and
prevent the processing circuitry from exiting the standby mode based on the second number.

12. A method comprising:
pausing execution of instructions by processing circuitry in response to a voltage glitch;
generating a number; and
unpausing the processing circuitry based on the number.

13. The method of claim 12, wherein the pausing of the execution of instructions by the processing circuitry includes preventing the processing circuitry from receiving a clock signal.

14. The method of claim 13, wherein the unpausing of the execution of instructions by the processing circuitry includes allowing the processing circuitry to receive the clock signal.

15. The method of claim 12, further including:
adjusting a count in response to the voltage glitch; and
causing the processing circuitry to enter standby mode based on the count.

16. The method of claim 12, further including:
determining that a subsequent voltage glitch is detected within a threshold duration of time after detecting the voltage glitch; and
causing the processing circuitry to enter standby mode in response to determining that the subsequent voltage glitch is detected within the threshold duration of time.

17. An apparatus comprising:
counter logic circuitry operable to adjust a count based on a voltage glitch; and
logic circuitry operable to cause processing circuitry to enter standby mode based on the count.

18. The apparatus of claim 17, wherein the logic circuitry is operable to prevent a terminal of the standby mode until a timer reaches a threshold duration.

19. The apparatus of claim 17, wherein the count is a count of clock pulses that occur after the voltage glitch, wherein the logic circuitry operatable to cause the processing circuitry to enter the standby mode if a subsequent voltage glitch is detected within a user-defined threshold amount of time.

20. The apparatus of claim 19, wherein the counter logic circuitry is operable to reset the count after the user-defined threshold amount of time.

21. The apparatus of claim 17, wherein the logic circuitry is operable to cause the processing circuitry to enter the standby mode by adjusting a value stored in a status register corresponding to the standby mode.

22. The apparatus of claim 17, wherein the count corresponds to a count of voltage glitches, wherein the logic circuitry is operable to cause the processing circuitry to enter standby mode when the count reaches a user-defined threshold.
